(19) United States
(12) Patent Application Publication
(10) Pub. No.: US 2020/0341308 A1
(43) Pub. Date: Oct. 29, 2020

(54) ACTIVE MATRIX SUBSTRATE AND DISPLAY DEVICE

(71) Applicant: SHARP KABUSHIKI KAISHA, Sakai City (JP)

(72) Inventor: YASUYOSHI KAISE, Sakai City (JP)

(21) Appl. No.: 16/855,641

(22) Filed: Apr. 22, 2020

(30) Foreign Application Priority Data
Apr. 26, 2019 (JP) 2019-086588

(51) Int. Cl. G02F 1/1368; G02F 1/1339

(52) U.S. Cl. CPC G02F 1/1368; G02F 2201/501; G02F 2201/52; G02F 1/1339

(57) ABSTRACT

An active matrix substrate is provided that is applicable to high-resolution liquid crystal panels, as well as to low-resolution liquid crystal panels, for improved video quality. An active matrix substrate includes: at least one thin film transistor for each subpixel; and light-blocking layers each overlapping a different group of a prescribed number of the thin film transistors, wherein the prescribed number is double the number of thin film transistors per pixel.

### BACKGROUND OF THE INVENTION

### Field of the Invention

The present invention relates to active matrix substrates and display devices.

### Background of the Invention

Active matrix TFT liquid crystal panels have been popularly used that include a lattice of electrodes to control pixels. The TFT liquid crystal panel typically includes light-blocking films on an active matrix substrate to restrain video quality degradation caused by, for example, crosstalk and flickering attributable to increasing leak current. Some relatively low-resolution TFT liquid crystal panels include such light-blocking films, one for each TFT channel or for the TFT channels in each single subpixel.

Japanese Unexamined Patent Application Publication, Tokukai, No. 2008-203734 (Publication Date: Sep. 4, 2008) discloses an electro-optical device including a light-blocking layer with a surface from which particles can be readily removed for improved productivity.

### SUMMARY OF THE INVENTION

Conventional art however has difficulty in manufacturing an active matrix substrate including light-blocking films if the active matrix substrate is to be used in high-resolution TFT liquid crystal panels.

The present invention, in an aspect thereof, has been made in view of this problem and has an object to provide an active matrix substrate that is applicable to high-resolution liquid crystal panels, as well as to low-resolution liquid crystal panels, for improved video quality.

To address the problem, the present invention, in an aspect thereof, is directed to an active matrix substrate including a plurality of pixels arranged in a matrix, each pixel including a plurality of subpixels for different colors, the active matrix substrate including: at least one thin film transistor for each subpixel; and light-blocking layers each overlapping a different group of a prescribed number of the thin film transistors, wherein the prescribed number is double the number of thin film transistors per pixel.

The present invention, in an aspect thereof, can provide an active matrix substrate that is applicable to high-resolution liquid crystal panels, as well as to low-resolution liquid crystal panels, for improved video quality.

### BRIEF DESCRIPTION OF DRAWINGS

FIG. 1 illustrates an exemplary active matrix substrate in accordance with Embodiment 1.

FIG. 2 illustrates an exemplary active matrix substrate.

FIG. 3 illustrates an exemplary active matrix substrate.

FIG. 4 illustrates an exemplary active matrix substrate.

FIG. 5 illustrates an exemplary active matrix substrate and photo spacers in accordance with Embodiment 2, the photo spacers being a component of a display device.

FIG. 6 illustrates an exemplary active matrix substrate and photo spacers in accordance with Embodiment 2, the photo spacers being a component of a display device.

### DESCRIPTION OF EMBODIMENTS

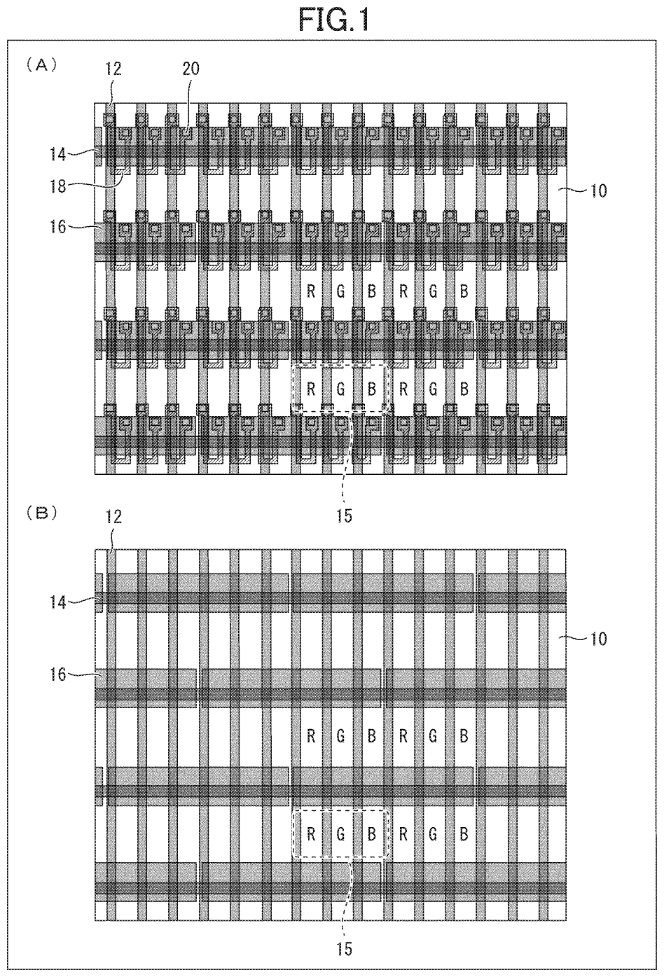

The following will describe embodiments of the present invention in detail with reference to FIGS. 1 to 6. The description of the present embodiment is for illustrative purposes only and by no means limits the scope of the invention unless specifically mentioned otherwise.

### Embodiment 1

A description will be given of an embodiment of the present invention with reference to FIGS. 1 to 4. The present embodiment takes, as an example, a display device including an active matrix substrate that is applicable to high-resolution liquid crystal panels, as well as to low-resolution liquid crystal panels, for improved video quality.

FIG. 1 illustrates an exemplary active matrix substrate 10 in a display device 1 in accordance with the present embodiment. FIG. 1 and subsequent drawings do not show some of the insulating films and other components of the active matrix substrate 10.

Referring to FIG. 1(A), there are provided source lines (source wiring) 12 in the column direction on the active matrix substrate 10 and gate lines (gate wiring) 14 in the row direction on the active matrix substrate 10. In other words, the source lines 12 and the gate lines 14 form a lattice of wires. There is provided a thin film transistor (TFT) near each one of the intersecting portions of the source lines 12 and the gate lines 14. The source lines 12 are connected to the sources of the TFTs, and the gate lines 14 are connected to the gates of the TFTs. The drains of the TFTs are connected to pixel electrodes. In the TFT, when a signal (voltage) is fed to the gate while a voltage is being applied to the source, a current flows between the source and the drain, thereby allowing the pixel electrode to store electric charge (i.e., charging the pixel electrode).

In the liquid crystal panel, liquid crystal molecules are rotated by the electric field generated between the pixel electrodes and the counter electrodes.

The liquid crystal panel may produce an on-screen display by so-called dot sequential driving, line sequential driving, or area sequential driving.

Each pixel 15 has subpixels corresponding to RGB (red, green, and blue) colors respectively. In this structure, the backlights themselves may produce red (R), green (G), and blue (B) light for the subpixels. Alternatively, there may be provided color filters on the opposite substrate.

There are provided two thin film transistors for each subpixel in the example shown in FIG. 1(A). There may alternatively be provided a single thin film transistor or three or more thin film transistors for each subpixel.

Light-blocking films (light-blocking layer) 16 are provided for the purpose of restraining video quality degradation caused by, for example, crosstalk and flickering attributable to increasing leak current. The light-blocking films 16 are made of a material that reflects little light. Examples of such materials for the light-blocking films 16 include high melting-point metals such as MO (molybdenum), W (tungsten), and Ta (tantalum).

Each light-blocking film 16 is provided overlapping a different group of a prescribed number of thin film transistors. The “overlapping” in this context does not necessarily mean that the light-blocking film 16 is in contact with the group of thin film transistors.

A semiconductor layer 18 is connected to the source lines 12 and the pixel electrodes via contact holes 20 formed through an insulating film.

FIG. 1(B) illustrates the same active matrix substrate 10 as FIG. 1(A), except that FIG. 1(B) does not show the semiconductor layer 18 and the contact holes 20. FIG. 1(B) shows that each light-blocking film 16 is provided overlapping a different group of a number of thin film transistors, the number corresponding to six subpixels. The prescribed number mentioned above is equal to 12, which is a product of 6 and 2 (the number of thin film transistors provided in each subpixel), in this example. The light-blocking films 16 are arranged in a staggered manner as shown in FIG. 1(B) so that the divisions are displaced in alternate rows. This structure contributes to the provision of the display device that can be viewed comfortably even through magnifying lenses.

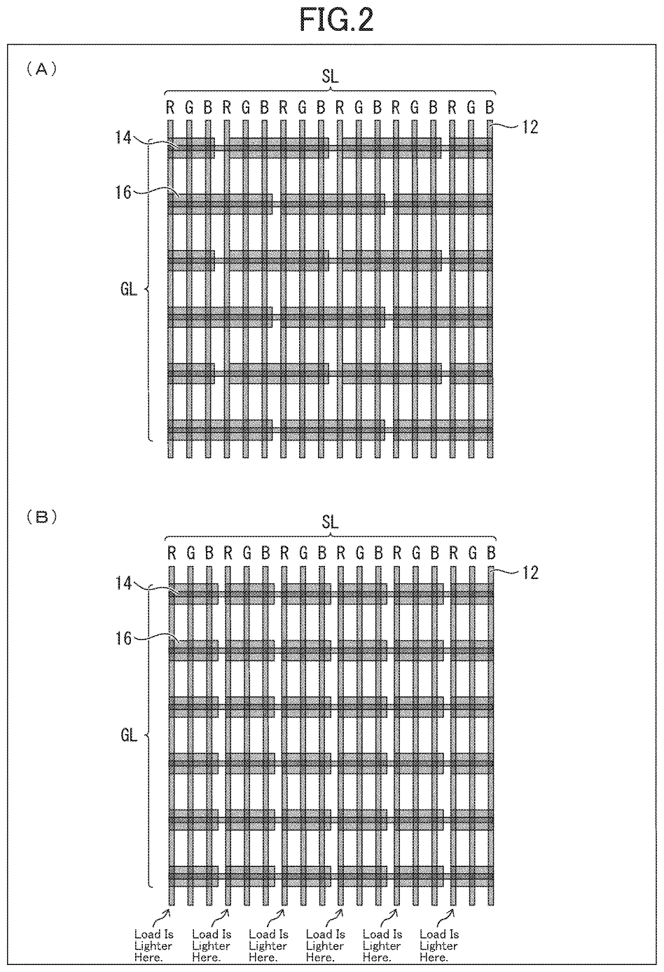

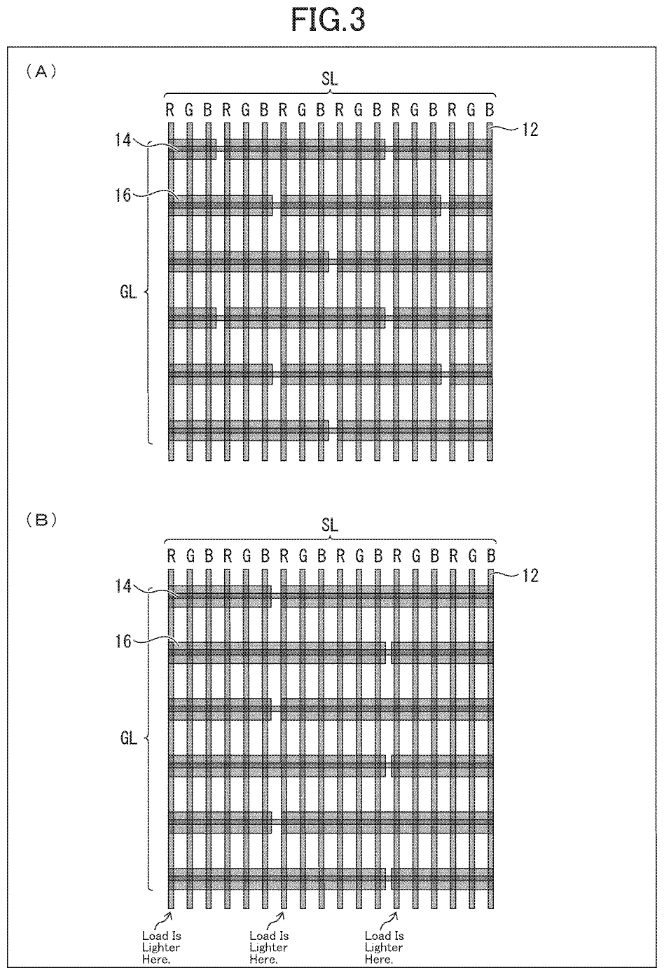

FIG. 2(A) is a different illustration of the active matrix substrate 10 from FIG. 1. FIGS. 2(B), 3(A), and 3(B) show comparative examples for the structure in FIG. 2(A) in accordance with the present embodiment. In the active matrix substrate 10 in FIG. 2(B), each light-blocking film 16 is provided overlapping a different group of a number of thin film transistors, the number corresponding to three subpixels. In the active matrix substrate 10 in FIG. 3(A), each light-blocking film 16 is provided overlapping a different group of a number of thin film transistors, the number corresponding to nine subpixels. In the active matrix substrate 10 in FIG. 3(B), each light-blocking film 16 is provided overlapping a different group of a number of thin film transistors, the number corresponding to 12 subpixels.

The active matrix substrate 10 in accordance with the present embodiment shown in FIG. 2(A) maintains load differences between the source lines 12 at low levels and is therefore unlikely to develop streaks and chromaticity discrepancies, thereby achieving good display quality, when compared with cases where each light-blocking film 16 is provided overlapping a different group of a number of thin film transistors, the number corresponding to three subpixels. Also when compared with these cases, the active matrix substrate 10 includes half the number of divisions of the light-blocking films 16, thereby reducing leaking light and hence achieving contrast improvement.

Meanwhile, in the active matrix substrate 10 shown in FIG. 2(B), those source lines 12 that overlap or reside near the divisions of the light-blocking films 16 have lighter loads than the other source lines 12, which possibly causes streaks and chromaticity discrepancies. In addition, the active matrix substrate 10 shown in FIG. 2(B) includes more divisions of the light-blocking films 16 and is therefore more susceptible to light leakage, thereby undesirably decreasing contrast, when compared with cases where each light-blocking film 16 is provided overlapping a different group of a number of thin film transistors, the number corresponding to six subpixels.

The active matrix substrate 10 shown in FIG. 3(A) includes divisions of the light-blocking films 16 arranged only in a single oblique direction, specifically, from the upper left to the lower right in the example of FIG. 3(A), which may possibly cause visible oblique streaks.

Meanwhile, the active matrix substrate 10 shown in FIG. 3(B) includes divisions of the light-blocking films 16 arranged periodically for every six source lines 12. This structure causes load differences between the source lines 12 for the same color, which possibly causes streaks and chromaticity discrepancies.

As described earlier, the active matrix substrate 10 in accordance with the present embodiment includes pixels each including subpixels corresponding to different colors. The active matrix substrate 10 further includes: at least one thin film transistor for every subpixel; and the light-blocking layers 16, each overlapping a different group of a prescribed number of thin film transistors. The prescribed number is equal to double the number of thin film transistors per pixel. The resultant active matrix substrate 10, structured in this manner, is applicable to high-resolution liquid crystal panels, as well as to low-resolution liquid crystal panels, for improved video quality.

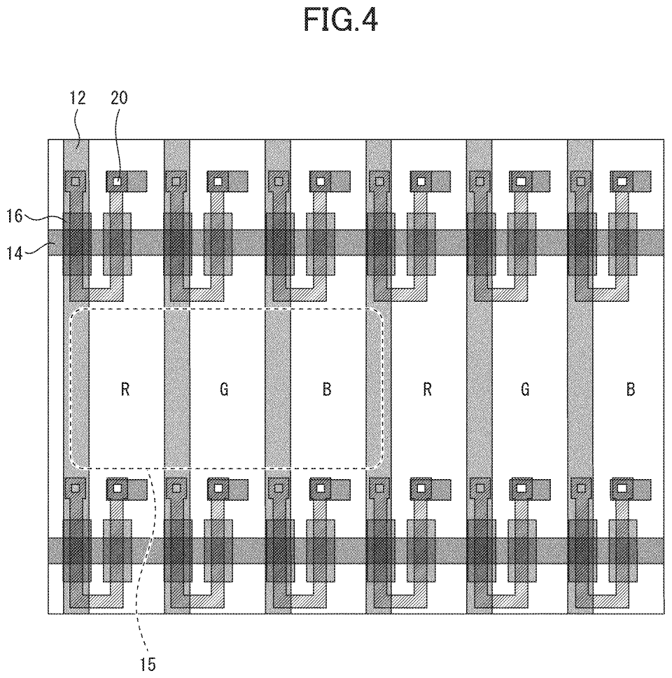

FIG. 4, corresponding to FIG. 1(A), illustrates a conventional active matrix substrate. If the active matrix substrate is incorporated in a low-resolution liquid crystal panel, the substrate provides a sufficient space thereon to mount thin film transistors and other components that there is no layout-related problem. The light-blocking films 16, in the above cases, may be arranged in a distributed manner for individual channels in the thin film transistors as shown in FIG. 4, so as to share the same loads between the source lines 12.

### Embodiment 2

The following will describe a second embodiment of the present invention. For convenience of description, members of the present and subsequent embodiments that have the same function as members described in the above embodiment will be indicated by the same reference numerals, and description thereof is not repeated.

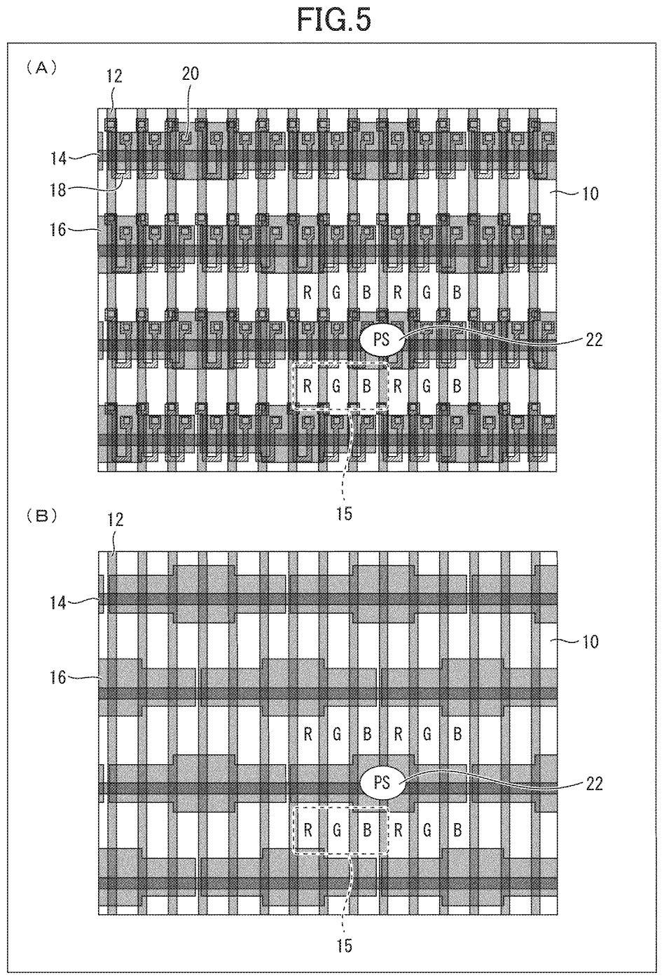

The present embodiment takes, as an example, a structure of a display device including an active matrix substrate and photo spacers. FIG. 5 illustrates an exemplary active matrix substrate 10 and photo spacers 22 in accordance with the present embodiment, the photo spacers 22 being a component of the display device.

Referring to FIG. 5, the photo spacers 22 are provided in order to maintain a distance between the substrates and shaped like, for example, columns. The photo spacers 22 are provided on an opposite substrate positioned before the active matrix substrate 10 with respect to the axial direction (front-back direction) perpendicular to the paper on which FIG. 5 is drawn. The photo spacers 22 have tip ends that are not necessarily in contact with the active matrix substrate 10.

FIG. 5(B) illustrates the same active matrix substrate 10 as FIG. 5(A), except that FIG. 5(B) does not show the semiconductor layer 18 and the contact holes 20. Each photo spacer 22 is disposed in a location corresponding to the center of the light-blocking film (light-blocking layer) 16 as shown in FIG. 5(B). Specifically, each photo spacer 22 is disposed in a location that, corresponding to a site between subpixels R and B, does not constitute a division of the light-blocking films 16. FIG. 5(B) shows that each light-blocking film 16 has a larger width in the middle portion than in the other portions. In other words, each light-blocking film 16 has a wide portion in the middle and a narrow portion in the non-middle portions. This structure enables the light-blocking film 16 to shield along the periphery of the photo spacer 22, as well as between the pixels 15, from light. In other words, the structure restrains light from leaking in the periphery of the photo spacer 22, thereby contributing to contrast improvement.

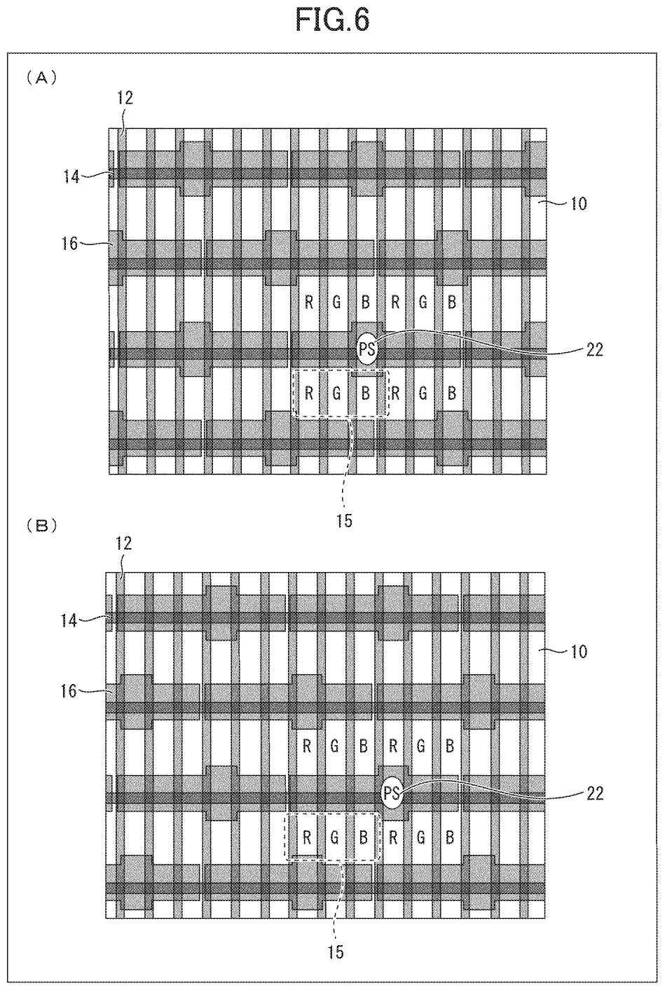

The photo spacers 22 are not necessarily disposed in locations between subpixels R and B. For instance, the photo spacers 22 may be provided in locations corresponding only to subpixels B as shown in FIG. 6(A). As another alternative, the photo spacers 22 may be provided in locations corresponding only to subpixels R as shown in FIG. 6(B). The structures in FIGS. 6(A) and 6(B) achieve the same advantageous effects as the structure shown as an example in FIG. 5.

### Embodiment 3

The following will describe a third embodiment of the present invention. Each pixel in Embodiment 1 includes three subpixels RGB (red, green, and blue). In contrast, each pixel includes four subpixels in the active matrix substrate 10 in accordance with the present embodiment. The four subpixels in this context may be subpixels corresponding, for example, to RGBW (red, green, blue, and white) colors.

In an example where there are provided two thin film transistors for each subpixel as in the structure shown in FIG. 1(A), each group of thin film transistors in the present embodiment includes 16 thin film transistors, which is double the number of thin film transistors per pixel. In other words, the active matrix substrate 10 in accordance with the present embodiment includes pixels each including four subpixels corresponding to four colors. The active matrix substrate 10 further includes: at least one thin film transistor for each subpixel; and the light-blocking films 16, each overlapping a different group of a number of thin film transistors, the number being double the number of thin film transistors per pixel. Preferably, the light-blocking films 16 are again arranged in a staggered manner in the present embodiment similarly to the arrangement shown in FIG. 1(B) so that the divisions are displaced in alternate rows. The same description applies to Embodiment 4 which will be described later.

This structure provides an active matrix substrate that is applicable to high-resolution liquid crystal panels, as well as to low-resolution liquid crystal panels, for improved video quality for example, when each pixel includes four RGBW (red, green, blue, and white) subpixels.

### Embodiment 4

The following will describe a fourth embodiment of the present invention. Similarly to Embodiment 3, each pixel includes four subpixels in the active matrix substrate 10 in accordance with the present embodiment. The display device 1 in accordance with the present embodiment including the active matrix substrate 10 includes photo spacers 22 each disposed in a location corresponding to the center of a light-blocking film 16, similarly to Embodiment 2.

For instance, when the four subpixels correspond respectively to the RGBW (red, green, blue, and white) colors and arranged in this sequence, and the light-blocking film 16 is provided overlapping from (the thin film transistor corresponding to) the subpixel R in a first pixel to the subpixel W in a second pixel adjacent to the first pixel, the photo spacer 22 may be disposed in a contiguous location corresponding to at least any subpixels from the subpixel G in the first pixel to the subpixel B in the second pixel. Related to a location corresponding to the center of the light-blocking film 16, particularly a location around the photo spacer 22, width may be larger than in the other portions similarly to Embodiment 2. In other words, each light-blocking film 16 may have a wide portion in the middle and a narrow portion in the non-middle portions.

### General Description

The present invention, in aspect 1 thereof, is directed to an active matrix substrate (10) including a plurality of pixels arranged in a matrix, each pixel (15) including a plurality of subpixels for different colors, the active matrix substrate including: at least one thin film transistor for each subpixel; and light-blocking layers (16) each overlapping a different group of a prescribed number of the thin film transistors, wherein the prescribed number is double the number of thin film transistors per pixel. This structure provides an active matrix substrate that is applicable to high-resolution liquid crystal panels, as well as to low-resolution liquid crystal panels, for improved video quality.

In aspect 2 of the present invention, the active matrix substrate of aspect 1 may be configured such that each pixel includes three subpixels, and the prescribed number is equal to a product of 6 and the number of thin film transistors per subpixel. This structure provides the active matrix substrate of aspect 1 when, for example, each pixel includes three RGB (red, green, and blue) subpixels.

In aspect 3 of the present invention, the active matrix substrate of aspect 1 may be configured such that each pixel includes four subpixels, and the prescribed number is equal to a product of 8 and the number of thin film transistors per subpixel. This structure provides the active matrix substrate of aspect 1 when, for example, each pixel includes four RGBW (red, green, blue, and white) subpixels.

In aspect 4 of the present invention, the active matrix substrate of aspect 1 or 2 may be configured such that the light-blocking films are arranged in a staggered manner on the active matrix substrate. This structure renders uniform all SL loads disposed between R-B, thereby producing no horizontal streaks attributable to SL charge ratio differences even in combination with Z-inversion (TFT zigzag design). A display device is therefore provided that has excellent video quality.

The present invention, in aspect 5 thereof, may be directed to A display device (1) including: the active matrix substrate of any one of aspects 1 to 4; and at least one photo spacer in a location corresponding to a center of each light-blocking layer. This structure restrains light from leaking in the periphery of the photo spacer, thereby contributing to contrast improvement.

In aspect 6 of the present invention, the display device of aspect 5 may be configured such that each light-blocking layer has: a wide portion in a middle portion thereof; and a narrow portion in a non-middle portion thereof. This structure further restrains light from leaking in the periphery of the photo spacer, thereby contributing to contrast improvement.

The present invention is not limited to the description of the embodiments above and may be altered within the scope of the claims. Embodiments based on a proper combination of technical means disclosed in different embodiments are encompassed in the technical scope of the present invention. Furthermore, a new technological feature can be created by combining different technological means disclosed in the embodiments.

What is claimed is:

1. An active matrix substrate including a plurality of pixels arranged in a matrix, each pixel including a plurality of subpixels for different colors, the active matrix substrate comprising:
at least one thin film transistor for each subpixel; and
light-blocking layers each overlapping a different group of a prescribed number of the thin film transistors, wherein
the prescribed number is double the number of thin film transistors per pixel.

2. The active matrix substrate according to claim 1, wherein
each pixel includes three subpixels, and
the prescribed number is equal to a product of 6 and the number of thin film transistors per subpixel.

3. The active matrix substrate according to claim 1, wherein
each pixel includes four subpixels, and
the prescribed number is equal to a product of 8 and the number of thin film transistors per subpixel.

4. The active matrix substrate according to claim 1, wherein the light-blocking layers are arranged in a staggered manner on the active matrix substrate.

5. A display device comprising:
the active matrix substrate according to claim 1; and
at least one photo spacer in a location corresponding to a center of each light-blocking layer.

6. The display device according to claim 5, wherein each light-blocking layer has: a wide portion in a middle portion thereof; and a narrow portion in a non-middle portion thereof.
